(19) United States
(12) Patent Application Publication
(10) Pub. No.: US 2007/0171980 A1
(43) Pub. Date: Jul. 26, 2007

(54) Method and Related Apparatus For Decoding Video Streams

(76) Inventor: Yen-Lin Lee, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/307,208

(22) Filed: Jan. 26, 2006

(51) Int. Cl. H04N 11/04; H04B 1/66

(52) U.S. Cl. 375/240.24; 375/240.29

(57) ABSTRACT

A method for decoding a picture of a video signal constructs a macroblock of the picture, stores a portion of the macroblock needed for an intra-prediction operation, and performs a de-blocking filter process for the macroblock.

### BACKGROUND OF THE INVENTION

1. Field of the Invention

The present invention provides a method for decoding video streams, and more particularly, a method for decoding video streams capable of pipelining decoding and de-blocking filtering processes one macroblock by one macroblock.

2. Description of the Prior Art

A wide range of new applications in visual communications have been made possible due to the rapidly evolving telecommunication and computer industries. Almost all the related applications, including video conferencing, mobile or PSTN video telephony, video over the Internet, and digital TV broadcasting, require very efficient data compression methods to fit a large amount of visual information into the narrow bandwidth of communication channels while preserving acceptable quality of the reconstructed data.

To efficiently compress a time variable video sequence, redundancy in the temporal domain as well as in the two dimensional spatial domain must be reduced. The Moving Picture Experts Group (MPEG) standards use a discrete cosine transform (DCT) for processing the steps of reducing the redundancy in the two dimensional spatial domain and a motion estimation method for processing the steps of reducing the redundancy in the temporal domain.

FIG. 1 shows a plurality of adjacent 4×4 pixel blocks 100, 102, 104 used according to the above described MPEG 4/AVG compression. In processing a moving picture as discussed above, these blocks 100, 102, 104 are individually processed to maximize the compression ratio and coding efficiency. However, this individual processing causes blocking artifacts that are noticeable at boundaries between blocks because of DCT and quantization effect. Both horizontal block boundaries 106 and vertical block boundaries 108 are present and tend to cause square patterns (blocking artifacts) that are quite apparent to the human eye.

In the traditional block-based video compression standards, the blocking artifact is the most noticeable artifact. Accordingly, various methods for reducing blocking artifacts in coding systems that individually processes blocks have been developed. Now, the de-blocking scheme is embedded in MPEG-4 standard, using a sophisticated in-loop de-blocking filter for the H.264/MPEG-4 AVC video coding standard. The in-loop de-blocking filter performs one-dimensional filtering along the block boundaries of a 4×4 or 8×8 block, which is the basic coding unit of the H.264 video codec. The in-loop de-blocking method improves both the subjective and objective quality.

For example, according to the MPEG 4/AVG, H.264 standard, the de-blocking filtering process is performed on a macroblock basis after the completion of a picture construction process prior to the de-blocking filtering process for the entire decoded picture, with all macroblocks in a picture processed in order of increasing macroblock addresses. That is, all macroblocks of the picture must be decoded and constructed to form the entire picture, some portion of the picture is used for intra-frame prediction, and finally, the de-blocking filtering process is performed on each macroblock of the picture to output the picture for displaying. Therefore, a picture must be constructed completely before the in-loop de-blocking filter, which is reasonable for a decoding scheme running step by step. However, in reality, if the de-blocking process is implemented by hardware, such as an application specific integrated circuit, or ASIC, the operation of the de-blocking process needs tremendous hardware resources (especially memory accesses), and is inefficient because total time for outputting a picture equals to time for decoding the entire picture plus time for de-blocking the entire picture.

Accordingly, due to the above limitations, the prior art is suitable for de-blocking filtering in smaller size pictures, and is unable to provide satisfactory results in larger size pictures (such as pictures having over 1920×1088 samples). It is because the larger picture intends that the more pixels or the more blocks should be sampled. However, the demand for de-blocking filtering of MPEG-encoded video is increasing due to the wide acceptance of MPEG applications, such as digital versatile discs (DVDs) and digital TV.

### SUMMARY OF THE INVENTION

It is therefore a primary objective of the claimed invention to provide a method and related apparatus for decoding video streams.

According to the claimed invention, a method for decoding a picture of a video signal constructs a macroblock of the picture, stores a portion of the macroblock needed for an intra-prediction operation, and performs a de-blocking filter process for the macroblock.

According to the claimed invention, a video signal decoder for decoding a picture of a video signal comprises a macroblock construction unit for constructing a macroblock of the picture, a buffer for storing a portion of the macroblock needed for an intra-prediction operation, and a de-blocking filter for performing a de-blocking filter process for the macroblock.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a plurality of adjacent 4×4 pixel blocks used according to the prior art MPEG 4, H.264 compression.

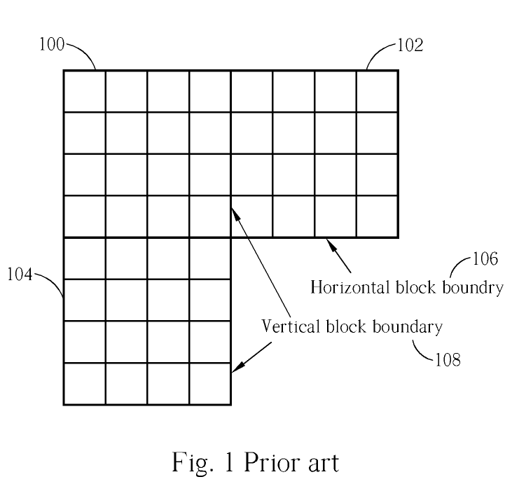

FIG. 2 illustrates a schematic diagram of a process for decoding a picture of a video stream in accordance with the present invention

### DETAILED DESCRIPTION

According to the MPEG 4 standard, a picture of a video stream must be constructed completely before the de-blocking filtering process, and that is because constructing the picture may use an intra-frame prediction operation, which requires data that has not yet performed the de-blocking process. That is, the intra-frame prediction operation uses non-filtered samples neighboring with a current macroblock in a picture to estimate pixel values of the macroblock. Therefore, when decoding a picture, a portion of a macroblock may be useful for decoding another macroblock.

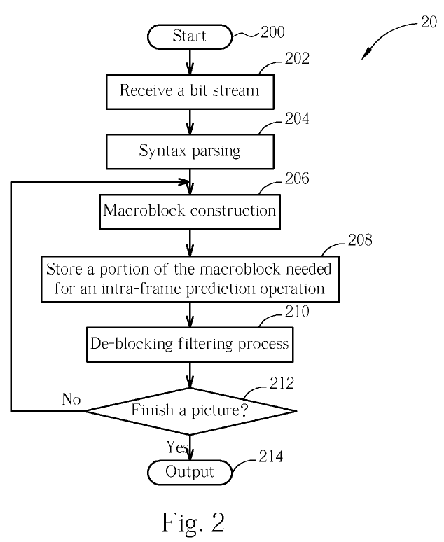

Please refer to FIG. 2, which illustrates a schematic diagram of a process 20 for decoding a picture of a video stream in accordance with the present invention. The process 20 includes following steps:

Step 200: start.

Step 202: receive a bit stream corresponding to the picture.

Step 204: determine a syntax of the bit stream.

Step 206: construct a macroblock of the picture from the bit stream according to the syntax.

Step 208: store a portion of the macroblock needed for an intra-frame prediction operation.

Step 210: perform a de-blocking filtering process for the macroblock.

Step 212: determine whether the picture is constructed or not. If so, go to next step, and if not, go to step 206.

Step 214: output the picture.

According to the process 20, while decoding a picture of a video stream, the present invention stores a portion of a current macroblock needed for the intra-frame prediction operation, so that the macroblock can continue the de-blocking filtering process to form a part of the picture. That is, after decoding and constructing the macroblock from the bit stream, a portion of the macroblock is stored in a buffer, and the macroblock has the de-blocking filtering process performed immediately. As a result, all the macroblocks of the picture need not to be decoded and constructed completely at the same time before the de-blocking filtering process, so that decoding efficiency is increased.

In comparison, the prior art must decode the entire picture completely before the in-loop de-blocking filter, while the present invention pipelines decoding and de-blocking filtering of each macroblock of the picture, which decreases memory access.

In short, the present invention stores data for the intra-frame prediction operation, which suspends the de-blocking filtering process in the prior art, to a storage device, such as a buffer, an external memory, etc. Then, the de-blocking filtering process can be performed one macroblock by one macroblock following the construction of each macroblock.

When implementing the process 20, a designer can allocate a buffer in an external memory for storing data for the intra-frame prediction operation. In order to make sure that the buffer is large enough to store the required data, the preferred buffer size equals to
2*(PicWidthInMbs+1)*(MbYInSam*BitDepY+2*MbCbInSam*BitDepC)

where PicWidthInMbs is a number of macroblocks in a horizontal axis of the picture, MbYInSam is a number of luma samples in a horizontal axis of a macroblock, MbCbInSam is a number of chroma samples in the horizontal axis of the macroblock, BitDepY is a number of bits in a luma sample, and BitDepC is a number of bits in a chroma sample.

Note that, the above equation for determining the buffer size is a preferred embodiment for determining a reliable memory space. Those skilled in the art can determine the buffer size regarding to required performance as long as the needed data for the de-blocking filtering operation can be stored properly. The process 20 is preferably implemented in a video codec of a video decoder of a consumer electrical device, such as mobile phones, video conferencing systems, digital TVs, HDTVs, graphics cards, etc.

For a 1920×1088 video stream of a 4:4:4 format displayed at 30 frames per second, the present invention can reduce 376 MB/s memory access. Accordingly, the present invention can reduce memory accesses, especially for decoding a high-resolution video stream, by storing a portion of a current macroblock needed for performing the intra-frame prediction on another macroblock, which increases decoding efficiency, and reduces system resources.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for decoding a picture of a video signal comprising following steps:
constructing a macroblock of the picture;
storing a portion of the macroblock needed for an intra-prediction operation; and
performing a de-blocking filter process for the macroblock.

2. The method of claim 1 further comprising receiving a bit stream corresponding to the picture.

3. The method of claim 1 further comprising determining a syntax of a bit stream corresponding to the picture.

4. The method of claim 3, wherein constructing the macroblock of the picture is constructing the macroblock of the picture from the bit stream according to the syntax.

5. The method of claim 1 further comprising constructing the picture.

6. The method of claim 5 further comprising outputting the picture.

7. The method of claim 1 further comprising performing the intra-prediction operation according to the stored portion of the macroblock.

8. The method of claim 1, wherein storing a portion of the macroblock needed for the intra-prediction operation is storing a portion of the macroblock needed for the intra-prediction operation in a buffer with a storage size determined according to a type of the picture.

9. The method of claim 8, wherein the storage size is [2*(PicWidthInMbs+1)*(MbYInSam*BitDepY+2*MbCbInSam*BitDepC)], where PicWidthInMbs is a number of macroblocks in a horizontal axis of the picture, MbYInSam is a number of luma samples in a horizontal axis of the macroblock, MbCbInSam is a number of chroma samples in the horizontal axis of the macroblock, BitDepY is a number of bits in a luma sample, and BitDepC is a number of bits in a chroma sample.

10. The method of claim 1, wherein the video signal is formed according to a standardization of MPEG 4/AVG, H.264 standard.

11. A video signal decoder for decoding a picture of a video signal comprising:
a macroblock construction unit for constructing a macroblock of the picture;
a buffer for storing a portion of the macroblock needed for an intra-prediction operation; and
a de-blocking filter for performing a de-blocking filter process for the macroblock.

12. The video signal decoder of claim 11, further comprising a bit stream receiver for receiving a bit stream corresponding to the picture.

13. The video signal decoder of claim 11, further comprising a control unit for constructing the picture after each part of the picture is received.

14. The video signal decoder of claim 13, further comprising an output unit for outputting the constructed picture.

15. The video signal decoder of claim 11, further comprising an intra-prediction operation unit for performing the intra-prediction operation according to the stored portion of the macroblock in the buffer.

16. The video signal decoder of claim 11, wherein a storage size of the buffer is determined according to a type of the picture.

17. The video signal decoder of claim 16, wherein the storage size is [2*(PicWidthInMbs+1)*(MbYInSam*BitDepY+2*MbCbInSam*BitDepC)], where PicWidthInMbs is a number of macroblocks in a horizontal axis of the picture, MbYInSam is a number of luma samples in a horizontal axis of the macroblock, MbCbInSam is a number of chroma samples in the horizontal axis of the macroblock, BitDepY is a number of bits in a luma sample, and BitDepC is a number of bits in a chroma sample.

18. The video signal decoder of claim 11, wherein the video signal is formed according to a standardization of MPEG 4/AVG, H.264 standard.
